(19) United States
(12) Patent Application Publication
(10) Pub. No.: US 2024/0240296 A1
(43) Pub. Date: Jul. 18, 2024

(54) COMPLEX CONCENTRATED SOFT MAGNETIC AMORPHOUS ALLOYS WITH MULTI-COMPLEX QUENCHED-IN NUCLEI AND MANUFACTURING METHOD THEREOF

(71) Applicant: SEOUL NATIONAL UNIVERSITY R&DB FOUNDATION, Seoul (KR)

(72) Inventors: Eun Soo PARK, Seoul (KR); Wookha RYU, Seoul (KR); Kyungjun KIM, Seoul (KR); Kook Noh YOON, Seoul (KR); Wan KIM, Seoul (KR)

(21) Appl. No.: 18/413,467

(22) Filed: Jan. 16, 2024

(30) Foreign Application Priority Data
Jan. 17, 2023 (KR) 10-2023-0007031

(51) Int. Cl. C22C 45/02; C22C 33/00; H01F 1/153

(52) U.S. Cl. CPC C22C 45/02; C22C 33/003; H01F 1/15308

(57) ABSTRACT

The present disclosure relates to a complex concentrated soft magnetic amorphous alloy with multi-complex quenched-in nuclei and a method for manufacturing the same, and more specifically, to a complex concentrated soft magnetic amorphous alloy which exhibits low coercivity while improving glass forming ability through the design of configurational entropy control complex alloying composition of a first main element group (Fe, Co, Ni), which determines the degree of magnetization as ferromagnetic metallic elements, a second alloying element group (B, Si, P, C), which facilitates amorphous formation, and a third cluster element group (Ca, Cu, Ag), which forms multi-complex quenched-in nuclei, and a method for manufacturing the same.

The complex concentrated soft magnetic amorphous alloy developed in the present disclosure is characterized by having an excellent switching effect in which the alloy is easily magnetized and demagnetized when a magnetic field is applied and removed by implementing low coercivity. In addition, the present disclosure provides guidelines for alloy development to develop a new alloy with excellent functionality realized by applying a complex concentrated alloy design method to amorphous alloy design. In addition, the present disclosure has presented a step of performing a precise heat treatment based on the (time)-(temperature)-(transformation) curve measurement of the manufactured complex concentrated soft magnetic amorphous alloy, thereby presenting a method capable of effectively controlling an amorphous structure control that has been optimized through the existing trial and error method based on the prediction.

### TECHNICAL FIELD

The present disclosure relates to a complex concentrated soft magnetic amorphous alloy with multi-complex quenched-in nuclei and a method for manufacturing the same, and more specifically, to a complex concentrated soft magnetic amorphous alloy which exhibits low coercivity through the formation of multi-complex quenched-in nuclei while improving glass forming ability through the design of configurational entropy control complex alloying composition of a first main element group (Fe, Co, Ni), which determines the degree of magnetization as ferromagnetic metal elements, a second alloying element group (B, Si, P, C), which facilitates amorphous formation with main ferromagnetic metal elements, and a third cluster element group (Ca, Cu, Ag), which forms multi-complex quenched-in nuclei, and a method for manufacturing the same.

### BACKGROUND ART

Amorphous metals are metallic materials that have a disordered atomic structure unlike the regular lattice structure of general crystalline metallic materials, and they are in the limelight as new alloy materials in various fields due to their excellent mechanical and functional properties arising from their unique structures. Amorphous alloys have been developed from alloy systems based on various commercial metal elements such as Zr, Ti, Cu, Fe, Al, and Ni. In particular, Fe-based amorphous alloys have received much attention as soft magnetic materials due to their high strength and excellent magnetic properties. It is known that Fe-based amorphous alloy systems generally can further improve the glass forming ability by containing metalloids and non-metal (B, C, Si, P) elements at around 15 atomic %, and adding additional elements such as Al, Y, etc.

Meanwhile, a complex concentrated alloy is also called a high entropy alloy, and is an alloy system in which plural metal elements are designed as the main constituent elements of the alloy, and it is characterized in that the atomic fractions of the main elements in the alloy are similar to each other so that high configurational entropy is caused. Since the high mixing entropy of the main elements in the complex concentrated alloy reduces the difference in Gibbs free energy between the liquid phase and the crystalline phase, the stability of the liquid phase may be reduced, and the glass forming ability may be reduced. However, on the other hand, high mixing entropy may become a cause to reduce the viscosity of the liquid phase and thus improve the glass forming ability. Therefore, if a complex concentrated alloy with controlled mixing entropy is formed when designing an amorphous alloy, the complex concentrated alloy may simultaneously have two possibilities of further improving the glass forming ability and rather reducing it.

An amorphous alloy is known to have a disordered atomic structure in principle, but this was evaluated against the atomic structure of a crystalline alloy with a long-range order lattice, and in reality, it may exhibit a locally characteristic bonding structure depending on the alloy manufacturing process, glass forming ability, etc. In general, the higher the cooling rate and the more excellent the glass forming ability of the alloy, the more it tends to exhibit a compositionally disordered amorphous (chemically homogeneous glass) structure that lacks local bonding structures. The lower the cooling rate and the poorer the glass forming ability of the alloy, it is easier to include various local bonding structures such as quasicrystal (icosahedral) structures, nanocrystals, etc. In order to utilize an amorphous alloy as a soft magnetic material, it is desirable for the alloy to exhibit low coercivity properties that allow it to be easily magnetized and demagnetized when a magnetic field is applied and removed. For this purpose, the size and distribution of the magnetic domain, which is the minimum structural unit where magnetization occurs in an alloy structure, is generally important. In order to reduce the coercivity, a method of heat-treating the Fe-based amorphous alloy to precipitate nanocrystal grains to a certain size and uniform distribution within the amorphous alloy matrix may be generally used, and in this case, a small and uniform magnetic domain distribution is formed so that there is an effect of greatly reducing the coercivity. Various amorphous alloy-based magnetic materials such as FINEMET, NANOMET, and NANOPERM have been developed by applying this methodology. However, in the case of such an alloy, since the step of manufacturing an amorphous alloy should be subsequently accompanied by additional heat treatment and cooling processes for crystalline phase precipitation, problems of reducing its productivity and economic feasibility occur. According to the above theoretical background, it can be seen that the coercivity properties depend on the size and distribution of the magnetic domain which are determined by the structural characteristics of the alloy. Therefore, when designing a complex amorphous alloy using multiple main elements as a matrix, there is a possibility of obtaining the positive effect of reducing the coercivity by controlling the size and distribution of the magnetic domain as well as the glass forming ability by controlling the distribution of various short-range ordered complex quenched-in nuclei in the amorphous matrix.

Although research has recently been reported on designing complex concentrated amorphous alloys by utilizing multiple main elements in amorphous alloys, the development has been made focusing on alloy systems such as Zr-based alloy systems with mechanical properties and excellent glass forming ability rather than Fe-based alloy systems with excellent magnetic properties. Therefore, to date, there has been no report on whether it is possible to develop a complex concentrated amorphous alloy and realize excellent low coercivity properties that exceed the characteristic limitations of existing amorphous alloys. Related art documents include Korean Patent Nos. 10-1055242, 10-1445238, and 10-1473763, but the current situation is that all specific element-centered amorphous alloys of Fe-based or Co-based systems are general amorphous alloys with Fe or Co as the main element.

### DISCLOSURE

### Technical Problem

The present disclosure is intended to overcome the limitations of the related art described above, and an object of the present disclosure is to provide a complex concentrated soft magnetic amorphous alloy which simultaneously exhibits an improved glass forming ability and low coercivity properties caused by effects such as local atomic bonding structure control and magnetic domain control by controlling the atomic-scale structure of the amorphous alloy to have multi-complex quenched-in nuclei through design control complex alloying of configurational entropy composition of a first main element group (Fe, Co, Ni), which determines the degree of magnetization as ferromagnetic metallic elements, a second alloying element group (B, Si, P, C), which facilitates amorphous formation, and a third cluster element group (Ca, Cu, Ag), which has the main ferromagnetic metallic elements and a positive heat of mixing to form multi-complex quenched-in nuclei, and a method for manufacturing the same.

### Technical Solution

In order to solve the above-described technical problem, according to one aspect of the present disclosure, there may be provided a complex concentrated soft magnetic amorphous alloy composed of an amorphous phase with multi-complex quenched-in nuclei.

The complex concentrated soft magnetic amorphous alloy is represented in atomic % by [Formula 1] below.

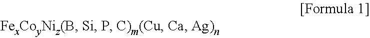

(Provided that, in Formula 1, x, y, z, m, and n mean at. %, 25≤x≤85, 0≤y≤30, 0≤z≤30, 5≤m≤30, 0<n≤5, 0<y+z≤60 and x+y+z+m+n=100, and two elements or more of the first main element group (Fe, Co, Ni), which determines the degree of magnetization as ferromagnetic metal elements, two elements or more of the second alloying element group (B, Si, P, C), which facilitates amorphous formation, and two elements or more of the third cluster element group (Ca, Cu, Ag), which forms multi-complex quenched-in nuclei, should be included.)

In Formula 1 above, in order to further increase the configurational entropy by including multiple metallic elements, one or more of the elements of the first main element group (Fe, Co, Ni) may be substituted with one or more of V, Cr, and Mn, which are 4-period transition elements.

In Formula 1 above, in order to promote the formation of multi-complex quenched-in nuclei through increased configurational entropy, three or more elements from one or more of the three groups of the first main element group, the second alloying element group, and the third cluster element group may be included.

The alloy is characterized by having an amorphous phase containing multi-complex quenched-in nuclei in the structure. In addition, the saturation magnetization (Bs) of the complex concentrated soft magnetic amorphous alloy may be predictable through [Equation 1] below.

$${B}_{s} 0.141 Δ {S}_{stand} + 0.14 X ( Co ) - 0.83 X ( Ni ) - 0.07 X ( Metalloid ) + 0.126 X ( Minors ) + 0.906 \qquad [ Equation 1 ]$$

(Provided that, ΔS_{stand} is quantified by normalizing the configurational entropy of the entire alloy through

$${x}_{norm} = \frac{x - {x}_{m i n}}{{x}_{m a x} - {x}_{m i n}}$$

and substituting this value into

$$s ( z ) = \frac{1}{1 + exp ( - z )} ,$$

and X(Co), X(Ni), X(Metalloid), and X(Minors) are each quantified variable values obtained by dividing the amount of Co, the amount of Ni, the amount of (B, Si, P, C), and the amount of (Ca, Cu, Ag) by the amount of Fe to obtain values, normalizing the obtained values through

$${x}_{norm} = \frac{x - {x}_{m i n}}{{x}_{m a x} - {x}_{m i n}}$$

and substituting these values into

$$s ( z ) = \frac{1}{1 + exp ( - z )} . )$$

According to another aspect of the present disclosure, there may be provided a method for manufacturing a complex concentrated soft magnetic amorphous alloy, the method including steps of: manufacturing a complex concentrated master alloy with the composition of [Formula 1] above; and amorphizing the complex concentrated master alloy to have multi-complex quenched-in nuclei to obtain a complex concentrated soft magnetic amorphous alloy.

### Advantageous Effects

The present disclosure constructed as described above has an effect of reducing the coercivity and improving the glass forming ability due to the formation of unique local atomic bonds with multi-complex quenched-in nuclei within the amorphous structure by manufacturing an amorphous alloy with maximized configurational entropy by substituting the ferromagnetic main metallic element Fe, which is a typical component of amorphous alloys that have been used as existing soft magnetic materials, with Co and Ni, and by simultaneously adding two or more out of B and Si as metalloid elements to improve glass forming ability and the non-metallic elements P and C, and two or more out of Ca, a paramagnetic metallic element that has a positive heat of mixing relationship with the main metallic elements, and diamagnetic metallic elements, Cu and Ag.

The complex concentrated soft magnetic amorphous alloy developed in the present disclosure is characterized by having an excellent switching effect in which the alloy is easily magnetized and demagnetized when a magnetic field is applied and removed by implementing low coercivity.

The present disclosure provides guidelines for alloy development to develop a new alloy with excellent functionality realized by applying a complex concentrated alloy design method to amorphous alloy design.

The present disclosure has presented a step of performing a precise heat treatment based on the (time)-(temperature)-(transformation) curve measurement of the manufactured complex concentrated soft magnetic amorphous alloy, thereby presenting a method capable of effectively controlling heat treatment for an amorphous structure control that has been optimized through the existing trial and error method based on the prediction.

### BRIEF DESCRIPTION OF DRAWINGS

FIG. 1 is a schematic diagram showing the reason for selecting elements for designing the complex amorphous soft magnetic alloy of the present disclosure.

FIGS. 2A and 2B show diffraction patterns obtained by measuring X-ray diffractions and synchrotron X-ray diffractions for Comparative Example 4 and Examples 1 to 3.

FIGS. 3A and 3B show diffraction patterns obtained by measuring X-ray diffractions and synchrotron X-ray diffractions for Comparative Example 9, Comparative Example 10, and Examples 11 to 13.

FIG. 4 shows diffraction patterns obtained by measuring X-ray diffractions for Comparative Example 12, Comparative Example 13, and Examples 18 to 20.

FIG. 5A shows magnetic hysteresis curves for Comparative Example 7, Comparative Example 8, and Examples 8 to 10 obtained by measuring magnetic properties in a vibrating sample magnetometer (VSM-7410) under conditions of a magnetic field of 10,000 Oe and room temperature.

FIG. 5B shows results of measuring the coercivity (Hc) values by enlarging the magnetic hysteresis curves of FIG. 5A near the saturation magnetization (Bs)=0.

FIG. 6 shows results of differential scanning calorimetry (DSC) for Comparative Example 7, Comparative Example 8, and Examples 8 to 10 of the present disclosure.

FIG. 7 shows a correlation of values in which changes in the Bs values of the complex amorphous soft magnetic alloys of the present disclosure are predicted by changes in configurational entropies and major added element contents through machine learning-based fitting.

FIG. 8A shows results of differential scanning calorimetry (DSC) for Comparative Example 10 and Example 17 of the present disclosure.

FIG. 8B shows a schematic diagram of the Flash DSC process control method for measuring the crystallization incubation time (τ) for the alloys of the present disclosure.

FIG. 8C shows a method for measuring the crystallization incubation time (τ) by showing Tg and Tx changes over time at each process condition.

FIG. 9 shows results of measuring the crystallization incubation time (τ) through the tendency of changes in Tg or Tx values measured through high-speed heating after different isothermal heat treatments of 360° C., 370° C., 380° C., 390° C., 400° C., and 410° C. for the composition of the present disclosure.

FIG. 10 shows a time-temperature-transformation diagram plotted using the crystallization incubation time (τ) measured in FIG. 9.

FIG. 11A is photographs of a small angle X-ray scattering (SAXS) apparatus mounted with a real-time heating device at the Pohang Light Source.

FIG. 11B shows SAXS measurement results during continuous heating and isothermal heat treatment for Comparative Example 10.

FIG. 11C shows SAXS measurement results during continuous heating and isothermal heat treatment for Example 17.

### MODE FOR INVENTION

With reference to the attached drawings, embodiments of the present disclosure will be described in detail so that those skilled in the art can easily implement the present disclosure. In order to clearly explain the present disclosure in the drawings, parts not related to the description are omitted, and the same reference numerals are used for identical or similar components throughout the specification. Additionally, in the case of publicly-known technologies that have been widely known, detailed descriptions thereof are omitted. Throughout the specification of this application, the composition unit of amorphous material is “at. %”, meaning the composition ratio of the number of atoms. Throughout this specification, “A and/or B” means “A and B, or A or B.” Meanwhile, throughout the specification, when a part is said to “include” a certain element, this means that it may further include other elements rather than excluding other elements unless specifically stated to the contrary.

Hereinafter, the present disclosure will be described in detail with reference to embodiments in order to describe the present disclosure in detail. The present disclosure may be implemented in many different forms and is not limited to the embodiments described herein. The embodiments of this specification are provided to more completely explain the present disclosure to those skilled in the art.

### Design of Complex Concentrated Soft Magnetic Amorphous Alloy

The amorphous alloy according to the present disclosure is composed of an amorphous phase with multi-complex quenched-in nuclei represented by [Formula 1] below through the design of configurational entropy control complex alloying composition of a first main element group (Fe, Co, Ni), which determines the degree of magnetization as ferromagnetic metallic elements; a second alloying element group (B, Si, P, C), which facilitates amorphous formation; and a third cluster element group (Cu, Ca, Ag), which has the main ferromagnetic metallic elements and a positive heat of mixing to form multi-complex quenched-in nuclei.

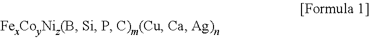

(Provided that, in Formula 1, x, y, z, m, and n mean at. %, 25≤x≤85, 0≤y≤30, 0≤z≤30, 5≤m≤30, 0<n≤5, 0<y+z≤60, and x+y+z+m+n=100.)

To elaborate on the formula above, the complex concentrated soft magnetic amorphous alloy necessarily contains two elements or more of the first main element group (Fe, Co, Ni), which are ferromagnetic metallic elements;
simultaneously necessarily contains two elements or more of the second alloying element group (B, Si, P, C) which consists of metalloid elements B and Si and non-metallic elements P and C; and
simultaneously necessarily contains two elements or more of the third cluster element group (Cu, Ca, Ag) consisting of diamagnetic metallic element Cu and paramagnetic metallic elements Ca and Ag.

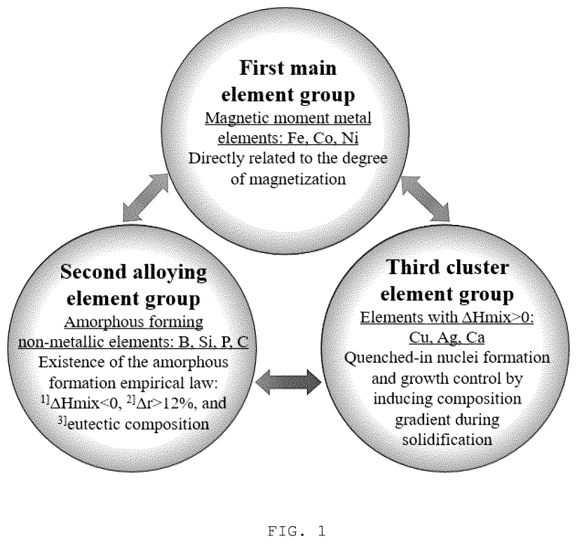

FIG. 1 is a schematic diagram showing the reason for selecting elements for designing the complex amorphous soft magnetic alloy of the present disclosure. As can be seen from the drawing, the present disclosure designed a complex concentrated soft magnetic amorphous alloy by simultaneously containing two elements or more from each element group of a first main element group (Fe, Co, Ni), which determines the degree of magnetization as magnetic moment metal elements, a second alloying element group, which facilitates amorphous formation by satisfying the empirical rules for glass formation ((1) ΔHₘᵢₓ<0, (2) Δr (atomic radius difference)>12%, and (3) existence of eutectic reaction), and a third cluster element group, which forms multi-complex quenched-in nuclei by inducing a compositional gradient during solidification without affecting the magnetization degree while having a ΔHₘᵢₓ>0 relationship with the first main element group.

The complex concentrated soft magnetic amorphous alloy of the present disclosure may satisfy a saturation magnetization (Bs) of 1 T or more, and particularly, the complex concentrated soft magnetic amorphous alloy may satisfy a Fe content of 50 at. % or more, and a saturation magnetization (Bs) of 1.5 T or more.

The complex concentrated soft magnetic amorphous alloy of the present disclosure may satisfy a coercivity (Hc) of 20 A/m or less. More specifically, the complex concentrated soft magnetic amorphous alloy may satisfy a coercivity of 20 A/m or less, less than 20 A/m, 19 A/m or less, 18 A/m or less, 17 A/m or less, 16 A/m or less, 15 A/m or less, 14 A/m or less, 13 A/m or less, 12 A/m or less, 11 A/m or less, or 10 A/m or less.

Particularly in [Formula 1], when three or more elements from one or more of the three groups of the first, second, and third element groups are included, the configurational entropy may be further increased to obtain the effect of further promoting the formation of multi-complex quenched-in nuclei while stabilizing the amorphous phase.

The results of manufacturing and evaluating an actual complex concentrated soft magnetic amorphous alloy according to the formula above are interpreted below. In this specification, the complex concentrated soft magnetic amorphous alloy sample was manufactured into a ribbon-shaped specimen with a thickness of 20 to 30 μm and a width of 2 to 3 mm by melting elements having a high purity of 99.9% or more through arc melting to produce a master alloy, and then using a melt spinning equipment to melt the master alloy through induction melting in a quartz tube in an Ar atmosphere chamber, and injecting the melted master alloy to a Cu wheel rotating at 3000 rpm and having a rotation speed of about 20 m/s under the pressure of Ar gas.

However, the melt spinning method of manufacturing the ribbon-shaped specimen for amorphous alloying is simply for the convenience of manufacturing, and the manufacturing method of the entire invention is not limited thereto. In addition to this, it can be expanded and applied to commercial metal manufacturing methods capable of manufacturing amorphous materials, such as mechanical alloying or gas atomization for producing powder-type specimens; and a quenching casting method using a copper mold of injection casting or suction casting for manufacturing bulk-type specimens.

To elaborate, a method for manufacturing a complex concentrated soft magnetic amorphous alloy according to the present disclosure may include the following steps of:
manufacturing a complex concentrated master alloy with the designed composition, and
obtaining a complex concentrated soft magnetic amorphous alloy by amorphizing the complex concentrated master alloy so as to have multi-complex quenched-in nuclei.

In the step of manufacturing the complex concentrated master alloy, the designed composition of the complex concentrated master alloy may follow the content described in the design of the complex concentrated soft magnetic amorphous alloy described above.

[Table 1] below shows whether the amorphous phase was formed or not confirmed through X-ray diffraction analysis and synchrotron X-ray diffraction analysis performed with respect to the compositions of Examples and Comparative Examples of the complex concentrated soft magnetic amorphous alloy of the present disclosure according to [Formula 1], and the measurement results of the saturation magnetization (Bs) and coercivity (Hc) obtained by measuring magnetic properties in a vibrating sample magnetometer (VSM-7410) under a magnetic field of 10,000 Oe and room temperature. In the phase configuration in Table 1 below, A means having a phase configuration of amorphous, A+C means having a phase configuration of amorphous+crystalline, and C means having a phase configuration of crystalline.

TABLE 1

| | | Phase | Bs | Hc |
|---|---|---|---|---|
| | Composition (at. %) | configuration | (T) | (A/m) |
| Comparative | Fe86Co1B10Si2Cu0.6Ag0.4 | C | — | — |
| Example 1 | | | | |
| Comparative | Fe82Ni5Co5B2Si2Cu2Ag2 | C | — | — |
| Example 2 | | | | |
| Comparative | Fe82Ni3Co1B8Si2Cu2Ag2Ca2 | C | — | — |
| Example 3 | | | | |
| Comparative | Fe82Ni3B8Si2P4Cu1 | A | 1.53 | 20.65 |
| Example 4 | | | | |
| Example 1 | Fe82Ni3B8Si2P4Cu0.6Ag0.4 | A | 1.68 | 10.22 |
| Example 2 | Fe82Ni3B8Si2P4Cu0.6Ca0.4 | A | 1.39 | 8.14 |
| Example 3 | Fe82Ni3B8Si2P4Cu0.5Ag0.3Ca0.2 | A | 1.49 | 5.74 |
| Comparative | Fe76Co9B10Si1P4 | A | 1.51 | 23.49 |
| Example 5 | | | | |
| Comparative | Fe75Co9B10Si1P4Cu1 | A | 1.54 | 22.25 |
| Example 6 | | | | |
| Example 4 | Fe75Co9B10Si1P4Cu0.6Ag0.4 | A | 1.61 | 10.35 |
| Example 5 | Fe75Co9B10Si1P4Cu0.6Ca0.4 | A | 1.58 | 4.77 |
| Example 6 | Fe75Co9B10Si1P4Cu0.5Ag0.3Ca0.2 | A | 1.55 | 15.12 |
| Example 7 | Fe75Co9B10Si1Cu4.5Ag0.3Ca0.2 | A | 1.54 | 14.94 |
| Comparative | Fe67Co18B14Si1 | A | 1.77 | 20.98 |
| Example 7 | | | | |
| Comparative | Fe66Co18B14Si1Cu1 | A | 1.66 | 25.5 |
| Example 8 | | | | |
| Example 8 | Fe66Co18B14Si1Cu0.6Ag0.4 | A | 1.64 | 16.47 |
| Example 9 | Fe66Co18B14Si1Cu0.6Ca0.4 | A | 1.65 | 18.3 |
| Example 10 | Fe66Co18B14Si1Cu0.5Ag0.3Ca0.2 | A | 1.7 | 10.35 |
| Comparative | Fe67Co18B10Si1P4 | A + C | 1.54 | 14 |
| Example 9 | | | | |
| Comparative | Fe66Co18B10Si1P4Cu1 | A + C | 1.56 | 13.54 |
| Example 10 | | | | |
| Example 11 | Fe66Co18B10Si1P4Cu0.6Ag0.4 | A | 1.59 | 10.7 |
| Example 12 | Fe66Co18B10Si1P4Cu0.6Ca0.4 | A | 1.53 | 9.78 |
| Example 13 | Fe66Co18B10Si1P4Cu0.5Ag0.3Ca0.2 | A | 1.54 | 7.42 |
| Comparative | Fe66Co9Ni9B14Si1Cu1 | A + C | 1.53 | 13.52 |
| Example 11 | | | | |
| Example 14 | Fe66Co9Ni9B14Si1Cu0.6Ag0.4 | A | 1.48 | 8.91 |
| Example 15 | Fe66Co9Ni9B10Si1P4Cu0.6Ag0.4 | A | 1.42 | 11.05 |
| Example 16 | Fe66Co9Ni9B10Si1P4Cu0.6Ca0.4 | A | 1.5 | 14.21 |
| Example 17 | Fe66Co9Ni9B10Si1P4Cu0.5Ag0.3Ca0.2 | A | 1.48 | 9.34 |
| Comparative | Fe49Co18Ni18B14Si1 | A + C | 1.44 | 19.85 |
| Example 12 | | | | |
| Comparative | Fe48Co18Ni18B14Si1Cu1 | A + C | 1.32 | 19.65 |
| Example 13 | | | | |
| Example 18 | Fe48Co18Ni18B14Si1Cu0.6Ca0.4 | A | 1.38 | 16.71 |
| Example 19 | Fe48Co18Ni18B13.5Si1C0, 5Cu0.6Ag0.4 | A | 1.31 | 15.26 |
| Example 20 | Fe48Co18Ni18B13Si1C1Cu0.5Ag0.3Ca0.2 | A | 1.37 | 13.57 |
| Comparative | Fe29Co28Ni28B14Si1 | A + C | 1.13 | 8.75 |
| Example 14 | | | | |
| Example 21 | Fe25V3Co28Ni28B14Si1Cu0.6Ag0.4 | A | 1.06 | 9.94 |
| Example 22 | Fe28Co22 (V2Cr2Mn2) Ni28B14Si1Cu0.6Ca0.4 | A | 1.16 | 12.8 |
| Example 23 | Fe28Co28Ni18Mn10B14Si1Cu0.5Ag0.3Ca0.2 | A | 1.12 | 11.07 |
| Example 24 | Fe28Co28Ni28B10Si1P4Cu0.6Ag0.4 | A | 1.1 | 5.57 |
| Example 25 | Fe28Co28Ni28B10Si1P4Cu0.6Ca0.4 | A | 1.06 | 4.77 |
| Example 26 | Fe28Co28Ni28B10Si1P4.5Cu0.3Ag0.2 | A | 1.1 | 8.57 |
| Example 27 | Fe28Co28Ni28B10Si1P2Cu1.5Ag0.9Ca0.6 | A | 1.06 | 6.77 |
| Example 28 | Fe28Co28Ni28B10Si1P4.7Cu0.1Ag0.1Ca0.1 | A | 1.02 | 7.85 |
| Comparative | Fe26Co32Ni32B8Si1Cu0.6Ag0.4 | C | — | — |
| Example 15 | | | | |
| Comparative | Fe26Co32Ni26B14Si1Cu0.6Ag0.4 | C | — | — |
| Example 16 | | | | |
| Comparative | Fe26Co21Ni21B26Si5Cu0.6Ag0.4 | C | — | — |
| Example 17 | | | | |
| Comparative | Fe24Co30Ni30B10Si5Cu0.6Ag0.4 | C | — | — |
| Example 18 | | | | |

As can be seen from Table 1, when the Fe content in the present disclosure is less than 25 at. % or more than 85 at. %, a crystalline phase is formed due to rapid deterioration of the glass forming ability, which is not desirable. In addition, since even when the Co and Ni contents each exceed 30 at. % and the Co+Ni content exceeds 60 at. %, the optimal composition range for amorphous formation changes due to changes in the base alloy to result in the formation of a crystalline phase, which is not desirable. In particular, when the contents of (B, Si, P, C) are less than 5 at. % for the amorphous forming composition of the present disclosure based on metal-metalloid bonding, which does not cause the effect of increasing packing density due to the atomic radius difference, resulting in a decrease in the glass forming ability, and when the contents of (B, Si, P, C) exceed 30 at. %, which greatly deviates from the optimal metal-metalloid ratio, and promotes the formation of intermetallic compounds such as boride, silicide, phosphide, and carbide, resulting in a decrease in the glass forming ability. Lastly, although the addition of (Cu, Ca, Ag) helps improve glass forming ability by adding a competing crystal phase, when the addition amount exceeds 5 at. %, which is not desirable since it acts as a nucleation site for the crystalline phase, resulting in a rapid decrease in the glass forming ability.

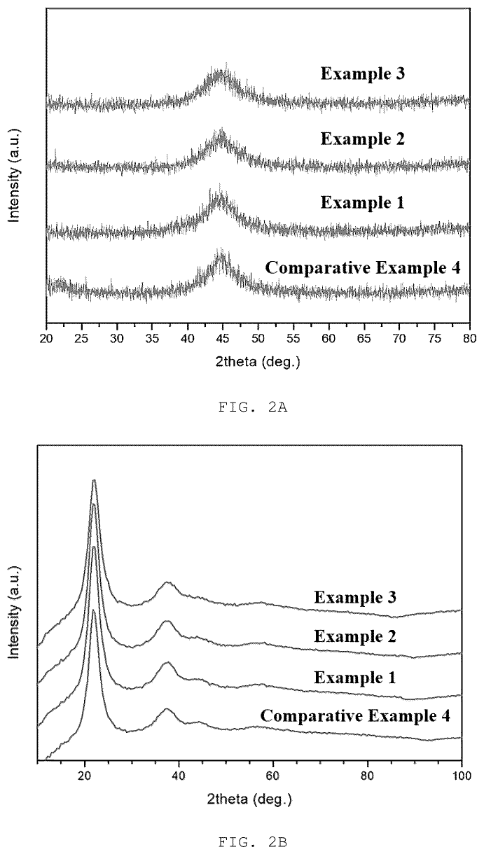

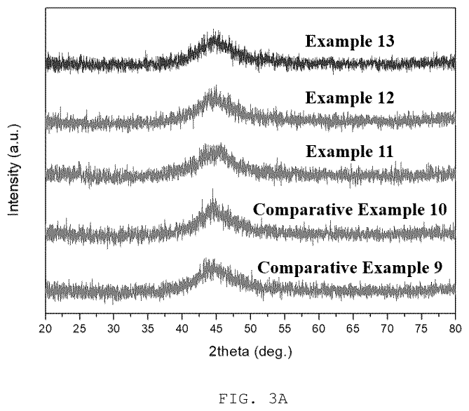

FIGS. 2A and 2B show diffraction patterns obtained by measuring X-ray diffractions and synchrotron X-ray diffractions for Comparative Example 4 and Examples 1 to 3. At this time, there are differences in that the above-described Comparative Example 4 contained the same amount of the third cluster element group, but the Comparative Examples contained one element, and the remaining Examples 1 to 3 contained two elements or more. As can be seen from the drawings, it can be seen that amorphization has occurred on the alloys of Comparative Example 4 and Examples 1 to 3 by obtaining measurement results that did not contain a specific crystalline sharp peak in a typical amorphous halo pattern through measurement of X-ray diffractions and synchrotron X-ray diffractions. In other words, even if two elements or more of the third element group are not necessarily included, amorphous materials may be manufactured by combining the element groups 1 and 2 at the same time. However, since Comparative Example 4 had a coercivity (Hc) value of 20.65 A/m, which is a value of 20 A/m or more, it can be seen that it is a more disordered amorphous state in which the distribution of the magnetic domain is present to be relatively less in the amorphous alloy. However, since it is necessary to apply a relatively large magnetic field for magnetization and demagnetization when such an amorphous alloy has a coercivity of 20 A/m or more, the amorphous alloy is not desirable as a soft magnetic material.

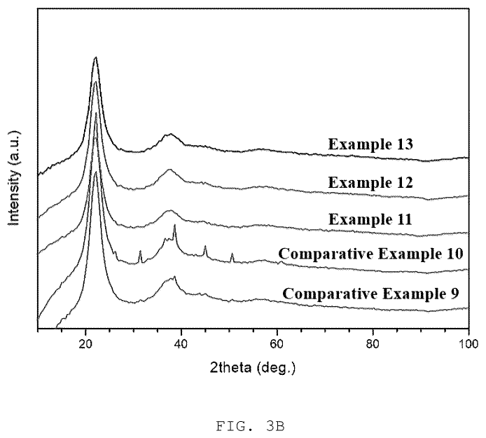

FIGS. 3A and 3B show diffraction patterns obtained by measuring X-ray diffractions and synchrotron X-ray diffractions for Comparative Example 9, Comparative Example 10, and Examples 11 to 13. As can be seen in FIG. 3A, no sharp peak for the formation of a crystal phase was observed through general X-ray diffraction analysis, but as can be seen in FIG. 3B, it can be confirmed that the amorphous matrix contains a crystalline phase in Comparative Example 10 and Comparative Example 11 through synchrotron X-ray diffraction measurement. At this time, Comparative Examples 9 and 10 contained 0 and one element of the third element group, respectively, and were confirmed to have excellent Bs and Hc values, but were analyzed to contain a crystalline phase. These results mean that the addition of two elements or more of the third element group in the present disclosure may improve glass forming ability through competition of multi-complex quenched-in nuclei. Therefore, it can be seen that two or more of the elements of each alloy group should be included in order to manufacture a complex concentrated soft magnetic amorphous alloy in which a crystalline phase is not formed while having multi-complex quenched-in nuclei.

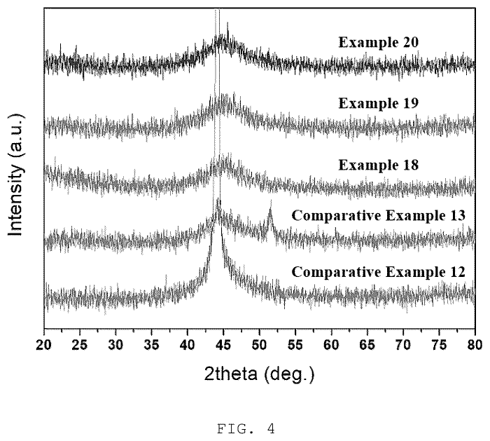

FIG. 4 shows diffraction patterns obtained by measuring X-ray diffractions for Comparative Example 12, Comparative Example 13, and Examples 18 to 20. As can be seen from the drawing, in the case of the alloys of Comparative Examples 12 and 13 unlike the alloys of Examples 18 to 20, a sharp peak indicating the inclusion of a crystalline phase was observed along with a diffuse halo peak as X-ray diffraction analysis results. Through this, Fe is contained in an amount of 50 at. % or less, and even if the glass forming ability is relatively further decreased due to an increase in the Co and Ni contents, it can be confirmed that the glass forming ability may be improved when two elements or more of each element group are included. Through the results analyzed above, it can be confirmed that it is desirable to include two elements or more of each element group at the same time in order to promote the formation of multi-complex quenched-in nuclei while seeking to stabilize the amorphous phase by increasing the configurational entropy.

Meanwhile, in order to further increase the configurational entropy by including multiple metallic elements as shown in Examples 21 to 23, some elements of the first main element group (Fe, Co, Ni) may be substituted with one or more of V, Cr, and Mn, which are 4-period transition elements. Such substitution may be made in an amount of 10 at. % or less of the total complex concentrated soft magnetic amorphous alloy as presented in Example 23.

### Evaluation of Magnetic Properties of Developed Amorphous Alloy

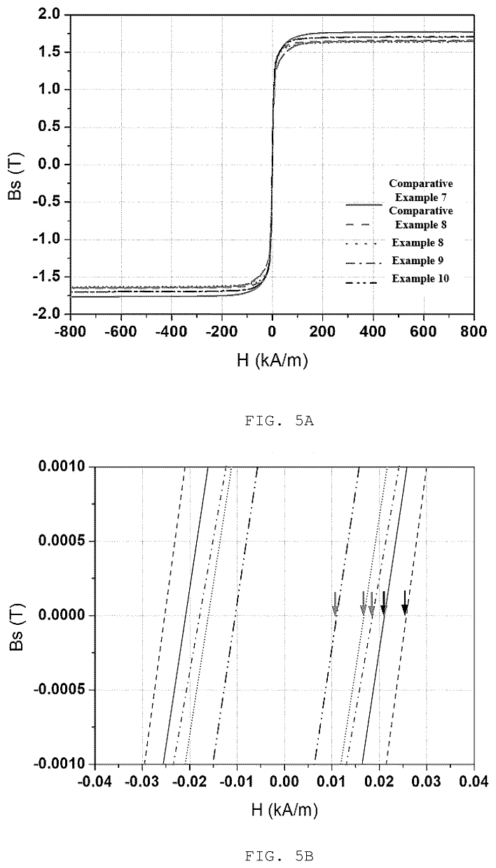

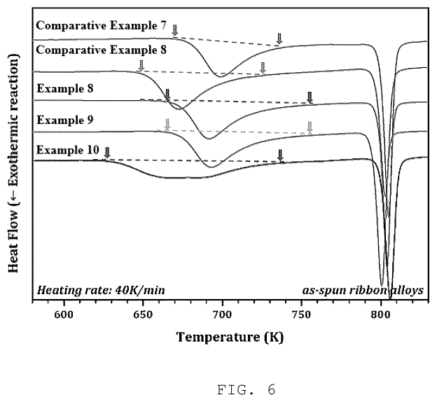

FIG. 5A shows magnetic hysteresis curves for Comparative Example 7, Comparative Example 8, and Examples 8 to 10 obtained by measuring magnetic properties in a vibrating sample magnetometer (VSM-7410) under conditions of a magnetic field of 10,000 Oe and room temperature. FIG. 5B shows results of measuring the coercivity (Hc) values by enlarging the magnetic hysteresis curves of FIG. 5A near the saturation magnetization (Bs)=0.

Referring to FIGS. 5A and 5B, in Comparative Example 7, Comparative Example 8, and Examples 8 to 10 of the present disclosure, typical diffraction curves of the amorphous alloy were obtained as results of measuring synchrotron X-ray diffractions. However, in the case of Comparative Examples 7 and 8, it could be confirmed that the coercivity (Hc) values were 20.98 A/m and 25.50 A/m, respectively, which were greater than 20 A/m, which was greater than 16.47, 18.30, and 10.35 A/m in Examples 8 to 10. As described above, if the amorphous alloy has a coercivity exceeding 20 A/m, it may be judged to be undesirable as a soft magnetic material since it requires the application of a relatively large magnetic field for magnetization and demagnetization. Therefore, it is preferable to exclude it from the scope of the claims of the present disclosure. This means that the formation of multi-complex quenched-in nuclei in the amorphous matrix in the present disclosure may relatively lower the Hc value by serving as a core dividing the magnetic domain. In other words, the higher the contents of elements such as Co, Ni, Ca, Ag, etc. added through complex alloying in the complex concentrated soft magnetic amorphous alloy according to the embodiment of the present disclosure, the lower the coercivity values, and particularly in Example 27, the lowest coercivity value of 4.77 A/m was found. Through this, structural control through sensitive subsequent heat treatment was essential in order to reduce the coercivity in existing soft magnetic amorphous and nanocrystalline alloys, but it was confirmed that the alloys of the Examples of this patent exhibited low coercivity values although they were not accompanied by heat treatment through the formation of multi-complex quenched-in nuclei in amorphous matrix.

FIG. 6 shows the results of performing differential scanning calorimetry (DSC) on the specimens of Comparative Example 7, Comparative Example 8, and Examples 8 to 10 of the present disclosure. As can be seen from the drawing, it could be seen that the crystallization peak of the α-Fe phase, which is the first crystallization behavior in the related alloy system, tends to have a lower height and a larger width in Examples 8 to 10 compared to Comparative Examples 7 and 8. In particular, in the case of Example 10, which contained three elements of the third group elements simultaneously, it could be confirmed that the peak height increased by half and the peak width increased by more than two times compared to Comparative Example 7. This tendency can be understood to be due to the sequential growth behavior of the multi-complex quenched-in nuclei during crystallization due to the formation of multi-complex quenched-in nuclei in which elements with positive heat of mixing in the amorphous matrix are used as nucleation sites in the case of the alloys of the Examples of the present disclosure. In particular, in the case of Example 10, when it has a relatively low Hc value of 10.35 A/m in a similar composition as described above, and contains three or more of one or more elements from each element group in order to promote the formation of complex quenched-in nuclei, it can be seen that the effect of the present disclosure can be increased.

### Prediction of Bs Properties of Complex Concentrated Soft Magnetic Amorphous Alloy

Meanwhile, since magnetic properties cannot be predicted before manufacturing an amorphous material, a lot of effort is needed to manufacture and evaluate it. To solve this, the present disclosure provides a statistical prediction equation that can predict the Bs value of an amorphous alloy having [Formula 1].

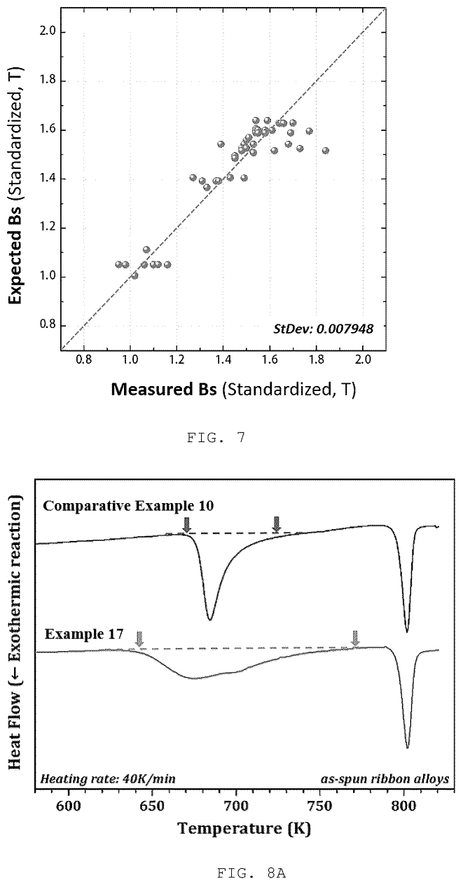

In fact, FIG. 7 shows a correlation of values in which changes in the Bs values of the complex amorphous soft magnetic alloys of the present disclosure shown in [Table 1] are predicted by a correlation between changes in configurational entropies and major added element contents through machine learning-based fitting, and the prediction equation that can predict this has been represented by the equation below. At this time, for accurate prediction of all variables, correlation equations were established only for the Examples, excluding all Comparative Examples in which a crystalline phase was precipitated.

$${B}_{s} 0.141 Δ {S}_{stand} + 0.14 X ( Co ) - 0.83 X ( Ni ) - 0.07 X ( Metalloid ) + 0.126 X ( Minors ) + 0.906 \qquad [ Equation 1 ]$$

To explain the above equation, first, the above equation includes five variables, and consists of (1) a variable for the configurational entropy that determines the characteristics of the entire alloy, (2) X(Co), which is a variable for the ratio of Co compared to the main element Fe, and (3) X(Ni), which is a variable for the ratio of Ni (respectively, the first element group), and finally, (4) X (Metalloid), which is the second element group compared to Fe, and (5) a variable for the ratio of X (Minor), which is the third element group. Below, the variables used in [Equation 1] are described in detail.

$$Δ S = - R {\sum }_{n = 1}^{W} {P}_{n} ln ( {P}_{n} ) \qquad [ Equation 2 ]$$

The configurational entropy value has a value calculated by [Equation 2] above. (At this time, R in the above equation represents the gas constant (8.314 J/mol), W represents the maximum number of cases that the system can have, and Pₙ represents the probability of the nth number of cases.)

Meanwhile, since other variables mean the contents of other elements compared to the Fe element, the normalization process of all variables through [Equation 3] below is essential for standardized comparison between entropy and other variables.

$${x}_{norm} = \frac{x - {x}_{m i n}}{{x}_{m a x} - {x}_{m i n}} \qquad [ Equation 3 ]$$

Xₙₒᵣₘ in [Equation 3] above means a normalized value, and Xₘᵢₙ and Xₘₐₓ mean the minimum and maximum variable values, respectively.

$$s ( z ) = \frac{1}{1 + exp ( - z )} \qquad [ Equation 4 ]$$

Lastly, in order to more closely compare all the variables normalized as above, all variables were substituted into [Equation 4] and quantified so that each had a sigmoid-type softmax distribution. This increases the difference between the respective variables when fitting variables, resulting in more accurate calculation results. Such a quantification process was also performed on Bs (saturation magnetization), which is the value to be predicted. As a result of predicting the Bs value by fitting a prediction equation in which each of such five variables is proportional in a polygonal linear equation, the result of [Equation 1] could be obtained, which is shown in FIG. 7.

In summary, ΔS in [Equation 1] is a value quantified by normalizing all configurational entropies calculated through [Equation 2] for each Example through [Equation 3], and finally, substituting such a normalized value into [Equation 4]. In addition, X(Co), X(Ni), X(Metalloid), and X(Minors), which are variables representing the alloy content ratio compared to remaining Fe, are variable values quantified by substituting the values obtained by dividing the amount of Co, the amount of Ni, the amount of the second element group, and the amount of the third element group by the amount of Fe alloyed in the relevant Examples, respectively, into [Equation 4].

As can be seen in FIG. 7, it can be seen that the Bs values of the alloys of the present disclosure match linearly well with the value predicted through [Equation 1] above. As a result of performing fitting on Bs changes of the alloys of the present disclosure through such a process, the equation for Bs as below was obtained, and it could be confirmed that the square of the average value of the difference between the experimental data and the predicted value through machine learning of the fitted result was 0.007948, which showed a very small value to have an excellent correlation. In particular, in the case of the alloy composition range of the present disclosure, it can be confirmed that the saturation magnetization (Bs) of the amorphous phase is 1 T or more. In addition, when the Fe content in the alloy was 50 at. % or more, it could be confirmed that the saturation magnetization (Bs) had an excellent value of 1.5 T or more. Therefore, the equation predicted through such a method has the effect of predicting the properties of the soft magnetic amorphous material developed in the present disclosure simply by composition.

### Subsequent Heat Treatment Through a TTT Diagram Drawn Based on Crystallization Incubation Time (τ) Measurement

The method for manufacturing a complex concentrated soft magnetic amorphous alloy according to the present disclosure may further include a step of additionally heat-treating the obtained complex concentrated soft magnetic amorphous alloy within the crystallization incubation time.

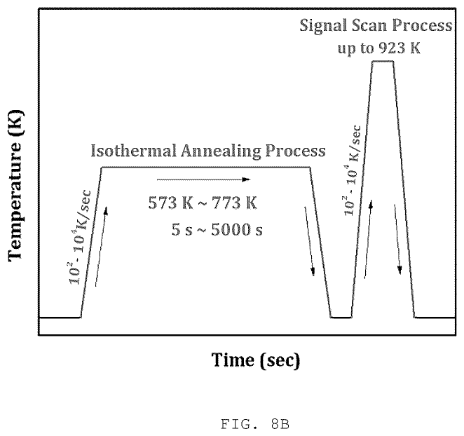

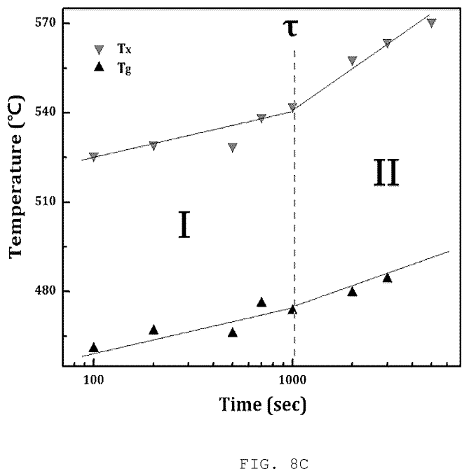

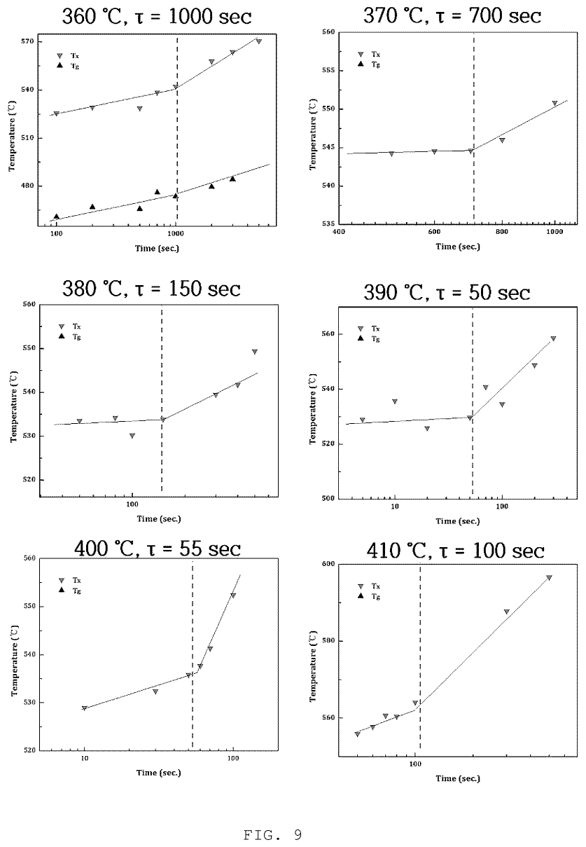

FIG. 8A shows results of differential scanning calorimetry (DSC) for Comparative Example 10 and Example 17 of the present disclosure. As previously explained in FIG. 7, it can be confirmed once again that the alloys of the present disclosure have a relatively low crystallization peak height and a wide crystallization temperature range due to sequential growth behavior due to the formation of multi-complex quenched-in nuclei in the amorphous matrix.

FIG. 8B shows a schematic diagram of the Flash DSC process control method for measuring the crystallization incubation time (τ) for the alloys of the present disclosure, and FIG. 8C typically shows a method for measuring the crystallization incubation time (τ) by showing changes in the glass transition temperature (Tg) and the crystallization onset temperature (Tx) over time for Comparative Example 10 at each process condition.

In general, in the case of amorphous alloys containing a large amount of Fe as in the present disclosure, since the Tg is not clear and the main element-based (main element en-rich) primary phase is precipitated, and thus the crystallization peak is not large, it is not easy to measure the crystallization incubation time.

In the present disclosure, a process control method of measuring a crystallization incubation time based on values in which the change tendency of Tg and Tx, especially the change tendency of Tx, is changed through reheating of a specimen cooled in a state in which the isothermal heat treatment time was varied after rapid heating through Flash DSC was developed. To elaborate, after all specimens were heated to a target temperature in a temperature range of 573 K to 773 K, which is the temperature range at which the first main element group such as α-Fe crystallizes, under fast heating conditions of a rate of 10² to 10⁴ K/sec, Tg and Tx changes were shown while continuously heating specimens, which were cooled to room temperature after performing the isothermal heat treatment for 5 to 5000 seconds at the target temperature, from room temperature to 923 K under rapid heating conditions of a rate of 10² to 10⁴ K/sec. As can be seen in FIG. 8C, the time at which the tendency of changing Tg and Tx was changed derived as the crystallization incubation time.

Referring to FIG. 8C, the crystallization incubation time could be obtained through the rapid change in the tendency (slope) of Tg or Tx which increases at around 1000 s during isothermal heat treatment at 360° C. Heat treatment before such a crystallization incubation time has the effect of suppressing the growth of crystal phases that have a critical nucleus size or more in addition to the additional formation of short-range order clusters in the amorphous matrix.

FIG. 9 shows results of measuring the crystallization incubation time (τ) through the tendency of changes in Tg or Tx values measured through high-speed heating after different isothermal heat treatments of 360° C., 370° C., 380° C., 390° C., 400° C., and 410° C. for the composition of the present disclosure. As the isothermal heat treatment temperature increases to 360° C., 370° C., 380° C., 390° C., 400° C., and 410° C., it could be confirmed that there was a tendency that the crystallization incubation time decreased to 1000 sec, 700 sec, 150 sec, 50 sec, and then increased again to 55 sec and 100 sec.

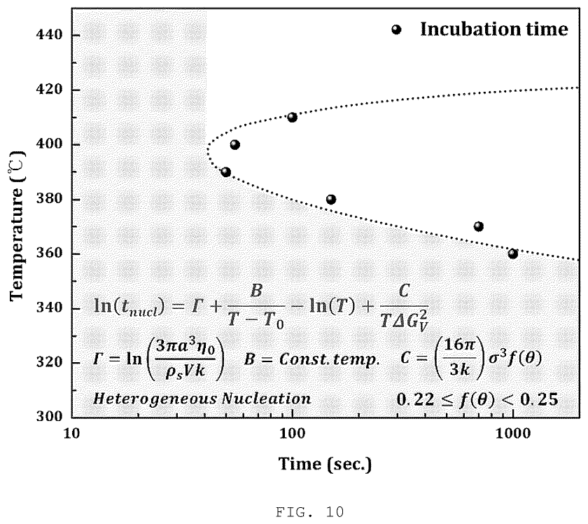

FIG. 10 shows a time-temperature-transformation diagram plotted using the crystallization incubation time (τ) measured in FIG. 9. The C curve for crystallization in the drawing was derived by assuming heterogeneous nucleation and fitting the crystallization incubation time obtained through [Equation 5] below.

$$ln ( τ ) = Γ + \frac{B}{T - {T}_{0}} - ln ( T ) + \frac{C}{T Δ {G}_{V}^{2}} \qquad [ Equation 5 ]$$

At this time, τ is the crystallization incubation time, B is a constant, T is the temperature, T₀ is the glass transition temperature obtained at an infinitely slow cooling rate obtained by extrapolation of Tg, and ΔG_{V} is the free energy change due to the change in the volume of crystallization, and C and Γ are preceding factors and are represented by [Equation 6] and [Equation 7] below.

$$C = ( \frac{16 π}{3 k} ) {σ}^{3} f ( θ ) \qquad [ Equation 6 ]$$

$$Γ = ln ( \frac{3 π {a}^{3} {η}_{0}}{{ρ}_{s} Vk} ) \qquad [ Equation 7 ]$$

At this time, σ is the difference in interfacial energy between the liquid phase and the crystal phase, k is the Boltzmann constant, f(θ) is the pre-catalytic factor with a value of 0.22 to 0.25, a is the radius of the crystalline phase, ρₛ is the density of the crystalline phase, η₀ is a constant for viscosity, and V is the volume of the crystalline phase.

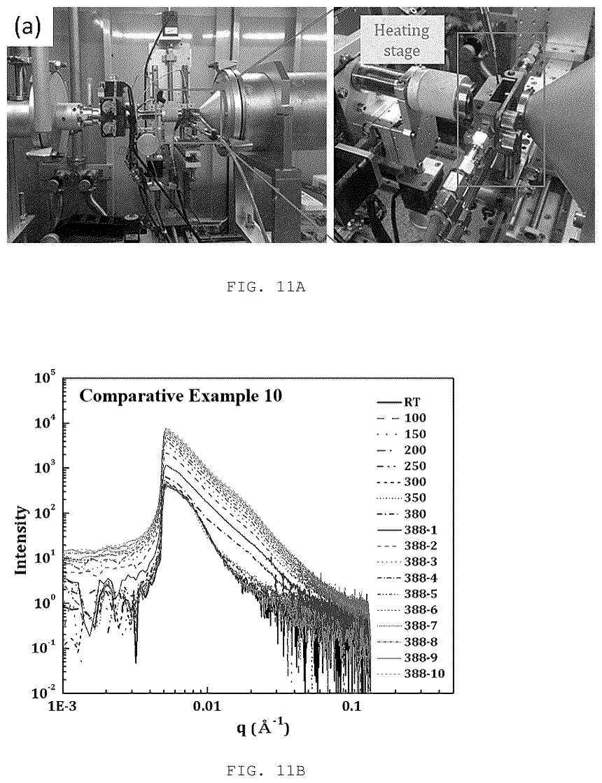

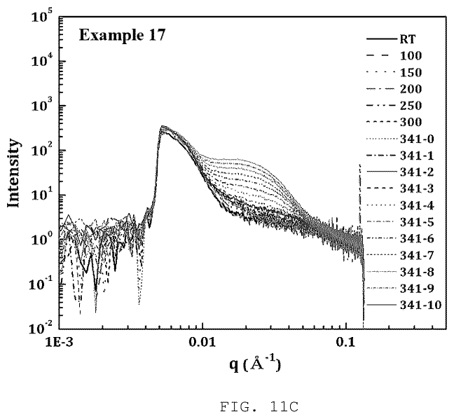

In the present disclosure, heat treatment of controlling the relative amount and distribution of multi-complex quenched-in nuclei in the amorphous matrix through heat treatment was performed under conditions of the range in which crystallization does not occur using the time-temperature-transformation curve drawn in this way (Shaded area in FIG. 10: supercooled liquid region of the melting temperature or less in the case of within the bottom of the C curve or the prior to the C curve nose point derived by fitting the measured crystallization incubation time through [Equation 5] above). FIG. 11A is photographs of a small angle X-ray scattering (SAXS) apparatus mounted with a real-time heating device at the Pohang synchrotron radiation accelerator. FIG. 11B shows SAXS measurement results during continuous heating and isothermal heat treatment (when performing heating under the bottom of the C curve) for Comparative Example 10. FIG. 11C shows SAXS measurement results during continuous heating and isothermal heat treatment (when performing heating under the bottom of the C curve) for Example 17. As can be seen in FIG. 11A, SAXS analysis is possible while performing heating in real time at the Pohang synchrotron radiation accelerator 4C beam line. As can be seen through FIGS. 11B and 11C, when heat treatment (continuous heating and isothermal heat treatment) is performed under the bottom of the C curve of each alloy (FIG. 11C) , as the growth of multi-complex quenched-in nuclei of about 20 nm occurs and heat treatment time (or temperature) increases in the alloy of Example 17 of the present disclosure, it can be seen that only its fraction gradually increases (the height only increases without moving the inflection point of the Guinier plot). On the other hand, in the case of alloy of Comparative Example 10 (FIG. 11B), it can be seen that as the heat treatment time (or temperature) increases, general crystallization occurs to gradually increase the size and fraction of the crystal phase so that the overall height increases as the inflection point of the Guinier plot moves to the low q range. Through this, in the case of the alloys of the present disclosure, when subsequent heat treatment is performed within the crystallization incubation time using the measured TTT diagram, it can be confirmed that the fraction of multi-complex quenched-in nuclei capable of causing a dispersion effect of the magnetic domain without rapid growth of the multi-complex quenched-in nuclei can be effectively increased. Structure control through such additional heat treatment may lead to improvement in magnetic properties of the present disclosure, especially a reduction in coercivity.

In summary, the step of heat-treating the obtained complex concentrated soft magnetic amorphous alloy based on (time)-(temperature)-(transformation) curve measurement may be performed by 1) rapidly heating the complex concentrated soft magnetic amorphous alloy to a target temperature in a range of 573 K to 773 K at a rate of 10² K/sec to 10⁴ K/sec, 2) performing isothermal heat treatment at the heated target temperature for 5 to 5000 seconds and then cooling a specimen to room temperature, 3) showing the change in the glass transition temperature (Tg) to the crystallization onset temperature (Tx) while continuously heating the specimen at a constant heating rate of room temperature to 923 K at the rate of 10² K/sec to 10⁴ K/sec, thereby 4) setting the point at which the change tendency of Tg or Tx changes as the crystallization incubation time (τ).

The present disclosure has been described above through preferred embodiments. The above-described embodiments are an exemplary illustration of the technical idea of the present disclosure, and those skilled in the art will understand that various changes are possible within the scope of the technical idea of the present disclosure. Therefore, the scope of protection of the present disclosure should be interpreted based on the matters stated in the patent claims, not the specific embodiments, and all technical ideas within the equivalent scope should be interpreted as being included in the scope of rights of the present disclosure.

1. A complex concentrated soft magnetic amorphous alloy represented by [Formula 1] below. 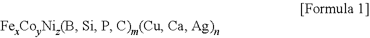
(Provided that, in Formula 1, x, y, z, m, and n mean at. %, 25≤x≤85, 0≤y≤30, 0≤z≤30, 5≤m≤30, 0<n≤5, 0<y+z≤60 and x+y+z+m+n=100, and two elements or more of a first main element group (Fe, Co, Ni), which determines the degree of magnetization as ferromagnetic metallic elements, two elements or more of a second alloying element group (B, Si, P, C), which facilitates amorphous formation, and two elements or more of a third cluster element group (Ca, Cu, Ag), which forms multi-complex quenched-in nuclei, should be included.)

2. The complex concentrated soft magnetic amorphous alloy of claim 1, wherein the complex concentrated soft magnetic amorphous alloy contains three or more elements from one or more of the three groups of the first, second, and third element groups.

3. The complex concentrated soft magnetic amorphous alloy of claim 1, wherein one or more of the elements of the first main element group (Fe, Co, Ni) are substituted with one or more of V, Cr, and Mn, which are 4-period transition elements, in an amount of 10 at. % or less of the complex concentrated soft magnetic amorphous alloy.

4. The complex concentrated soft magnetic amorphous alloy of claim 1, wherein the complex concentrated soft magnetic amorphous alloy based on the first major element group (Fe, Co, Ni) has an amorphous phase with multi-complex quenched-in nuclei.

5. The complex concentrated soft magnetic amorphous alloy of claim 1, wherein the saturation magnetization (Bs) of the complex concentrated soft magnetic amorphous alloy is predictable through [Equation 1] below.
$$[ Equation 1 ]$$
$${B}_{s} = 0.141 Δ {S}_{stand} + 0.14 X ( Co ) - 0.83 X ( Ni ) - 0.07 X ( Metalloid ) + 0.126 X ( Minors ) + 0.906$$
(Provided that, ΔS_{stand} is quantified by normalizing the configurational entropy of the entire alloy through
$${x}_{norm} = \frac{x - {x}_{min}}{{x}_{max} - {x}_{min}}$$
and substituting this value into
$$s ( z ) = \frac{1}{1 + exp ( - z )} ,$$
and X(Co), X(Ni), X(Metalloid), and X(Minors) are each quantified variable values obtained by dividing the amount of Co, the amount of Ni, the amount of (B, Si, P, C), and the amount of (Ca, Cu, Ag) by the amount of Fe to obtain values, normalizing the obtained values through
$${x}_{norm} = \frac{x - {x}_{min}}{{x}_{max} - {x}_{min}}$$
and substituting these values into
$$s ( z ) = \frac{1}{1 + exp ( - z )} . )$$

6. The complex concentrated soft magnetic amorphous alloy of claim 1, wherein the complex concentrated soft magnetic amorphous alloy has a saturation magnetization (Bs) of 1 T or more.

7. The complex concentrated soft magnetic amorphous alloy of claim 1, wherein the complex concentrated soft magnetic amorphous alloy has a Fe content of 50 at. % or more, and a saturation magnetization (Bs) of 1.5 T or more.

8. The complex concentrated soft magnetic amorphous alloy of claim 1, wherein the complex concentrated soft magnetic amorphous alloy has a coercivity (Hc) of 20 A/m or less.

9. A method for manufacturing a complex concentrated soft magnetic amorphous alloy comprising steps of:
manufacturing a complex concentrated master alloy with the composition of [Formula 1] below; and
obtaining a complex concentrated soft magnetic amorphous alloy by amorphizing the complex concentrated master alloy so as to have multi-complex quenched-in nuclei. 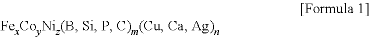
(Provided that, in Formula 1, x, y, z, m, and n mean at. %, 25≤x≤85, 0≤y≤30, 0≤z≤30, 5≤m≤30, 0<n≤5, 0<y+z≤60 and x+y+z+m+n=100, and two elements or more of a first main element group (Fe, Co, Ni), which determines the degree of magnetization as ferromagnetic metallic elements, two elements or more of a second alloying element group (B, Si, P, C), which facilitates amorphous formation, and two elements or more of a third cluster element group (Ca, Cu, Ag), which forms multi-complex quenched-in nuclei, should be included.)

10. The method of claim 9, wherein in the step of manufacturing a complex concentrated master alloy with the composition of [Formula 1] above, the complex concentrated soft magnetic amorphous alloy contains three or more elements from one or more of the three groups of the first, second, and third element groups.

11. The method of claim 9, wherein in the step of manufacturing a complex concentrated master alloy with the composition of [Formula 1] above, one or more of the elements of the first main element group (Fe, Co, Ni) are substituted with one or more of V, Cr, and Mn, which are 4-period transition elements, in an amount of 10 at. % or less of the complex concentrated master alloy.

12. The method of claim 9, wherein the step of obtaining a complex concentrated soft magnetic amorphous alloy by amorphizing the complex concentrated master alloy so as to have multi-complex quenched-in nuclei uses: a method for manufacturing a powder-type specimen through mechanical alloying or gas atomization capable of rapid solidification; a method for manufacturing a ribbon-shaped specimen through melt-spinning; or a method for manufacturing a bulk-type specimen using a copper mold of injection casting or suction casting.

13. The method of claim 9, wherein the saturation magnetization (Bs) of the complex concentrated soft magnetic amorphous alloy is predictable through [Equation 1] below.
$$[ Equation 1 ]$$
$${B}_{s} = 0.141 Δ {S}_{stand} + 0.14 X ( Co ) - 0.83 X ( Ni ) - 0.07 X ( Metalloid ) + 0.126 X ( Minors ) + 0.906$$
(Provided that, ΔS_{stand} is quantified by normalizing the configurational entropy of the entire alloy through
$${x}_{norm} = \frac{x - {x}_{min}}{{x}_{max} - {x}_{min}}$$
and substituting this value into
$$s ( z ) = \frac{1}{1 + exp ( - z )} ,$$
and X(Co), X(Ni), X(Metalloid), and X(Minors) are each quantified variable values obtained by dividing the amount of Co, the amount of Ni, the amount of (B, Si, P, C), and the amount of (Ca, Cu, Ag) by the amount of Fe alloyed in the concerned Examples to obtain values, normalizing and substituting these the obtained values through
$${x}_{norm} = \frac{x - {x}_{min}}{{x}_{max} - {x}_{min}}$$
and substituting these values into
$$s ( z ) = \frac{1}{1 + exp ( - z )} . )$$

14. The method of claim 9, wherein the complex concentrated soft magnetic amorphous alloy has a saturation magnetization (Bs) of 1 T or more.

15. The method of claim 9, wherein the complex concentrated soft magnetic amorphous alloy has a Fe content of 50 at. % or more, and a saturation magnetization (Bs) of 1.5 T or more.

16. The method of claim 9, wherein the complex concentrated soft magnetic amorphous alloy has a coercivity (Hc) of 20 A/m or less.

17. The method of claim 9, further comprising a step of additionally heat-treating the obtained complex concentrated soft magnetic amorphous alloy within the crystallization incubation time after the step of obtaining a complex concentrated soft magnetic amorphous alloy by amorphizing the complex concentrated master alloy so as to have multi-complex quenched-in nuclei.

18. The method of claim 17, wherein the crystallization incubation time (τ) is measured through steps of:
1) rapidly heating the complex concentrated soft magnetic amorphous alloy to a target temperature in a range of 573 K to 773 K at a rate of 10² K/s to 10⁴ K/sec;
2) isothermal heat-treating the complex concentrated soft magnetic amorphous alloy at the target temperature for 5 to 5000 seconds and then cooling it to room temperature;
3) showing the changes in glass transition temperature (Tg) or crystallization onset temperature (Tx) while continuously heating the complex concentrated soft magnetic amorphous alloy from room temperature to 923 K at a rate of 10² K/s to 10⁴ K/sec; and
4) checking the point in time when the change tendency of the Tg or Tx changes.

19. The method of claim 18, wherein the step of additionally heat-treating the complex concentrated soft magnetic amorphous alloy within the crystallization incubation time is performed using a (time)-(temperature)-(transformation) curve drawn through the measured crystallization incubation time.

20. The method of claim 19, wherein the step of additionally heat-treating the complex concentrated soft magnetic amorphous alloy within the crystallization incubation time using the (time)-(temperature)-(transformation) curve drawn through the measured crystallization incubation time is performed under (time)-(temperature) conditions within the C curve derived by fitting the measured crystallization incubation time through [Equation 2] below (provided that, in the case of the prior to the C curve nose, the supercooled liquid region within the melting temperature).
$$ln ( τ ) = Γ + \frac{B}{T - {T}_{0}} - ln ( T ) + \frac{C}{T Δ {G}_{V}^{2}} \qquad [ Equation 2 ]$$
(Provided that, τ is the crystallization incubation time, B is a constant, T is the temperature, T₀ is the glass transition temperature obtained at an infinitely slow cooling rate obtained by extrapolation of Tg, and ΔG_{V} is the free energy change due to the change in the volume of crystallization, and C and Γ are preceding factors and are
$$C = ( \frac{16 π}{3 k} ) {σ}^{3} f ( θ ) and Γ = ln ( \frac{3 π {a}^{3} {η}_{0}}{{ρ}_{s} Vk} ) ,$$
respectively, σ is the difference in interfacial energy between the liquid phase and the crystalline phase, k is the Boltzmann constant, f(θ) is the pre-catalytic factor with a value of 0.22 to 0.25, a is the radius of the crystalline phase, ρₛ is the density of the crystalline phase, η₀ is a constant for viscosity, and V is the volume of the crystalline phase.)
